(19) United States
(12) Patent Application Publication
(10) Pub. No.: US 2025/0254682 A1
(43) Pub. Date: Aug. 7, 2025

(54) METHOD AND APPARATUS FOR FREQUENCY DOMAIN RESOURCE ASSIGNMENT ON MULTIPLE CARRIERS

(71) Applicant: Lenovo (Beijing) Limited, Beijing (CN)

(72) Inventor: Haipeng Lei, Beijing (CN)

(73) Assignee: Lenovo (Beijing) Limited, Beijing (CN)

(21) Appl. No.: 18/853,026

(22) PCT Filed: Apr. 1, 2022
(86) PCT No.: PCT/CN2022/084827

§ 371 Date: Sep. 30, 2024

(51) Int. Cl. H04W 72/1268; H04L 5/00; H04W 72/232

(52) U.S. Cl. CPC H04W 72/1268; H04L 5/001; H04W 72/232

(57) ABSTRACT

Embodiments of the present disclosure relate to methods and apparatuses for frequency domain resource assignment on multiple carriers scheduled by a single DCI. According to some embodiments of the disclosure, a UE may: determine a payload size of a DCI format, wherein the DCI format schedules a first plurality of carriers of a second plurality of carriers, wherein the second plurality of carriers is configured by a BS; receive, from the BS, the DCI format according to the determined payload size, wherein the first plurality of carriers is indicated by a first indicator of the DCI format or is configured by the BS; determine RBs assigned on the first plurality of carriers based on the DCI format; and receive downlink transmissions on the assigned RBs in the case that the DCI format schedules the downlink transmissions, or transmit uplink transmissions on the assigned RBs in the case that the DCI format schedules the uplink transmissions.

### TECHNICAL FIELD

Embodiments of the present disclosure generally relate to wireless communication technology, and more particularly to frequency domain resource assignment on multiple carriers scheduled by a single downlink control information (DCI).

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, a user equipment (UE) may monitor a physical downlink control channel (PDCCH) in one or more search spaces. The PDCCH may carry downlink control information (DCI), which may schedule uplink channels, such as a physical uplink shared channel (PUSCH), or downlink channels, such as a physical downlink shared channel (PDSCH).

There is a need for handling frequency domain resource assignment for uplink and downlink transmissions scheduled by a DCI in a wireless communication system.

### SUMMARY

Some embodiments of the present disclosure provide a user equipment (UE). The UE may include: a transceiver; and a processor coupled to the transceiver. The processor may be configured to: determine a payload size of a downlink control information (DCI) format, wherein the DCI format schedules a first plurality of carriers of a second plurality of carriers, wherein the second plurality of carriers is configured by a base station (BS); receive, from the BS, the DCI format according to the determined payload size, wherein the first plurality of carriers is indicated by a first indicator of the DCI format or is configured by the BS; determine resource blocks (RBs) assigned on the first plurality of carriers based on the DCI format; and receive downlink transmissions on the assigned RBs in the case that the DCI format schedules the downlink transmissions, or transmit uplink transmissions on the assigned RBs in the case that the DCI format schedules the uplink transmissions.

Some embodiments of the present disclosure provide a base station (BS). The BS may include: a transceiver; and a processor coupled to the transceiver. The processor may be configured to: configure a second plurality of carriers for a user equipment (UE); transmit, to the UE, a downlink control information (DCI) format for scheduling a plurality of resource blocks (RBs) on a first plurality of carriers of the second plurality of carriers for transmission, wherein the first plurality of carriers is indicated by a first indicator in the DCI format or configured to the UE by the BS; and transmit downlink transmissions on the plurality of RBs in the case that the DCI format schedules downlink transmissions, or receive uplink transmissions on the plurality of RBs in the case that the DCI format schedules uplink transmissions.

Some embodiments of the present disclosure provide a method for wireless communication performed by a user equipment (UE). The method may include: determining a payload size of a downlink control information (DCI) format, wherein the DCI format schedules a first plurality of carriers of a second plurality of carriers, wherein the second plurality of carriers is configured by a base station (BS); receiving, from the BS, the DCI format according to the determined payload size, wherein the first plurality of carriers is indicated by a first indicator of the DCI format or is configured by the BS; determining resource blocks (RBs) assigned on the first plurality of carriers based on the DCI format; and receiving downlink transmissions on the assigned RBs in the case that the DCI format schedules the downlink transmissions, or transmit uplink transmissions on the assigned RBs in the case that the DCI format schedules the uplink transmissions.

Some embodiments of the present disclosure provide a method for wireless communication performed by a BS. The method may include: configuring a second plurality of carriers for a user equipment (UE); transmitting, to the UE, a downlink control information (DCI) format for scheduling a plurality of resource blocks (RBs) on a first plurality of carriers of the second plurality of carriers for transmission, wherein the first plurality of carriers is indicated by a first indicator in the DCI format or configured to the UE by the BS; and transmitting downlink transmissions on the plurality of RBs in the case that the DCI format schedules downlink transmissions, or receive uplink transmissions on the plurality of RBs in the case that the DCI format schedules uplink transmissions.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a schematic diagram of a DCI format scheduling a plurality of transmissions in accordance with some embodiments of the present disclosure;

FIG. 3 illustrates an exemplary radio resource allocation in accordance with some embodiments of the present disclosure;

FIG. 4 illustrates an exemplary radio resource allocation in accordance with some embodiments of the present disclosure;

FIG. 5 illustrates an exemplary radio resource allocation in accordance with some embodiments of the present disclosure;

FIG. 6 illustrates a flow chart of an exemplary procedure of wireless communications in accordance with some embodiments of the present disclosure;

FIG. 7 illustrates a flow chart of an exemplary procedure of wireless communications in accordance with some embodiments of the present disclosure; and

FIG. 8 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

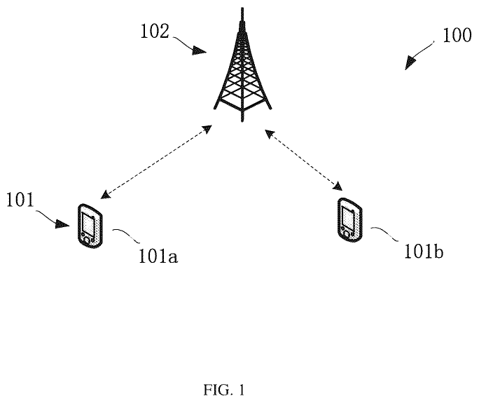

FIG. 1 illustrates a schematic diagram of a wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

A communication technology (e.g., NR) may support a wide range of spectrums in different frequency ranges. For example, in the market for 5G Advanced, it is expected that the availability of the spectrum will be increased, which is possibly due to re-farming the bands originally used for previous cellular generation networks. For example, for some low frequency bands of frequency range 1 (FR1) (e.g., 410 MHz-7125 MHz), the available spectrum bands tend to be more fragmented and scattered with a narrower bandwidth. In addition, for bands of frequency range 2 (FR2) (e.g., 24250 MHz-52600 MHz) and some bands of FR1, the available spectrum may be wider such that an intra-band multi-carrier operation is necessary.

To meet different spectrum needs, it is important to ensure that these fragmented or scattered spectrum bands or spectrums with wider bandwidth are utilized in a more spectrum and power efficient and flexible manner, thereby providing higher throughput and decent coverage in the network.

For example, one motivation is to increase spectrum/power efficiency and flexibility on scheduling data over multiple cells including intra-band cells and inter-band cells. In some examples, scheduling mechanisms may only allow scheduling a single PUSCH or PDSCH on a single cell per a scheduling DCI. As more scattered spectrum bands or spectrums with wider bandwidth become available, it is advisable to allow simultaneous scheduling of multiple cells.

A communication system (e.g., NR) may be designed to support a maximum of 16 component carriers (CCs) in the case of CA or a maximum of 32 CCs in the case of dual connectively (DC). In some embodiments of the present application, in the case of CA, one DCI can schedule at most one carrier by cross-carrier scheduling or self-scheduling. This requires much signaling overhead for PDCCHs to schedule PDSCHs or PUSCHs when the number of carriers configured for a UE is large. To reduce signaling overhead, it would be beneficial to use a single DCI to schedule multiple PDSCHs or PUSCHs on multiple carriers configured to the UE.

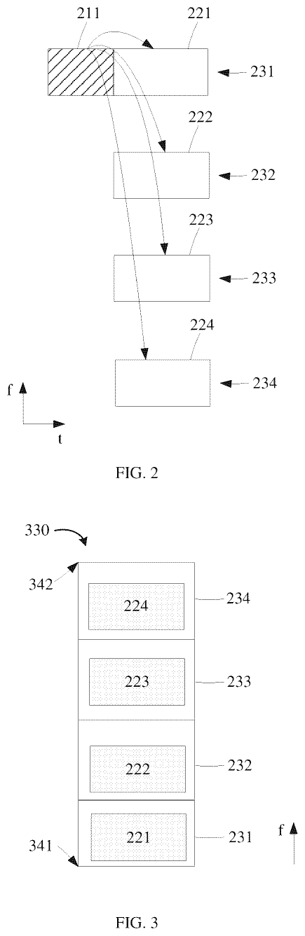

FIG. 2 illustrates a schematic diagram of a DCI format scheduling a plurality of transmissions in accordance with some embodiments of the present disclosure.

In some embodiments of the present disclosure, a plurality of CCs (e.g., including but not limited to CCs 231-234 in FIG. 2) may be configured for a UE. It should be understood that the sub-carrier spacings (SCSs) of the carriers configured for a UE may be the same or different. Each of the plurality of CCs may correspond to a respective serving cell of the UE. Each serving cell may be associated with a serving cell index.

As shown in FIG. 2, instead of using four DCI formats to respectively schedule four transmissions (e.g., transmissions 221-224 in FIG. 2) on four carriers (e.g., CCs 231-234), a BS may transmit a single DCI format 211 to schedule the four transmissions on the four carriers. In some examples, transmissions 221-224 may be uplink transmissions, e.g., PUSCHs. In some examples, transmissions 221-224 may be downlink transmissions, e.g., PDSCHs.

Although in FIG. 2 the carrier (i.e., CC 231) on which DCI format 211 is detected carries one of the scheduled transmissions 221-224, it should be understood that DCI format 211 may be on a carrier configured for the UE which is different from the carriers (i.e., CCs 231-234) which carry the scheduled transmissions 221-224. It also should be understood that a carrier (e.g., a CC) scheduled by a DCI format may carry more than one transmissions (e.g., PDSCHs or PUSCHs). For example, a DCI format may schedule two PDSCHs on CC 232.

When a DCI format schedules a single transmission on a single carrier, the DCI format may indicate the frequency domain resources assigned on the scheduled carrier for the scheduled transmission. This may not be applicable when a single DCI format schedules a plurality of transmissions (e.g., PDSCHs or PUSCHs) on a plurality of carriers. For example, since different carriers may use different numerologies and may have different bandwidths, the single frequency domain resource assignment (FDRA) in the single DCI format may not be applicable to the plurality of scheduled carriers, or it would cause much scheduling restriction. In some embodiments, a separate FDRA field for each of the scheduled carriers in a DCI format may be employed. However, this would lead to huge signaling overhead in the scheduling DCI. Embodiments of the present application propose improved solutions for indicating the FDRAs for the scheduled carriers, which can reduce the overhead.

On the other hand, before detecting a DCI format, a UE needs to know the exact payload size of the DCI format. Since the number of carriers scheduled by a DCI format may be dynamically changed, it would impact the DCI payload size. As a result, how to determine the payload size of the DCI format should also be resolved.

More details on the embodiments of the present disclosure will be illustrated in the following text in combination with the appended drawings. It should be noted that the solutions of the present disclosure can be applied to both downlink transmissions (e.g., PDSCHs) and uplink transmissions (e.g., PUSCHs) scheduled by a DCI format.

In some embodiments of the present disclosure, in the case that a single DCI format can schedule multiple carriers (also called “serving cells”) for downlink or uplink transmission, an indicator (e.g., a single FDRA field) of the DCI format indicates the resource blocks (RBs) assigned on the scheduled carriers. The scheduled carriers may be virtually combined into a virtual carrier according to a certain principle. The FDRA field in the DCI format indicates the assigned RBs on the virtual carrier.

For example, all RBs on all the scheduled carriers are virtually combined and contiguously numbered among all the scheduled carriers with reference to a starting RB from the starting RB to an ending RB. From the UE's perspective, the frequency resources of all the scheduled carriers are combined and can be logically regarded as a wider carrier (e.g., virtual carrier). The bandwidth of the virtual carrier may exceed the limitation of a predefined maximum number of RBs per carrier (e.g., 275 RBs) due to the contiguous RB numbering for all the scheduled carriers.

Various methods may be applied to combining the scheduled carriers and numbering the RBs. For example, the scheduled carriers may be combined according to a predefined order (for example, carrier indexes or frequency locations of the scheduled carriers).

In some embodiments, the scheduled carriers may be combined into the virtual carrier according to an ascending order of carrier indices of the scheduled carriers. In some examples, the lowest RB on the lowest carrier (e.g., lowest in the frequency domain) among the scheduled carriers in the virtual carrier may be used as the starting RB for numbering the RBs of the virtual carrier. The highest RB on the highest carrier (e.g., highest in the frequency domain) among the scheduled carriers in the virtual carrier may be used as the ending RB for numbering the RBs of the virtual carrier. In some other examples, the highest RB on the highest carrier among the scheduled carriers in the virtual carrier may be used as the starting RB for numbering the RBs of the virtual carrier. The lowest RB on the lowest carrier among the scheduled carriers in the virtual carrier may be used as the ending RB for numbering the RBs of the virtual carrier.

In some embodiments, the scheduled carriers may be combined into the virtual carrier according to an ascending order of carrier frequency of the scheduled carriers. In some examples, the lowest RB on the lowest carrier among the scheduled carriers in the virtual carrier may be used as the starting RB for numbering the RBs of the virtual carrier. The highest RB on the highest carrier among the scheduled carriers in the virtual carrier may be used as the ending RB for numbering the RBs of the virtual carrier. In some other examples, the highest RB on the highest carrier among the scheduled carriers in the virtual carrier may be used as the starting RB for numbering the RBs of the virtual carrier. The lowest RB on the lowest carrier among the scheduled carriers in the virtual carrier may be used as the ending RB for numbering the RBs of the virtual carrier.

FIG. 3 shows an example method for combining CCs 231-234 scheduled by DCI format 211 in FIG. 2 as a virtual carrier and numbering the virtual carrier. It is assumed that the values of serving cell indexes of CCs 231-234 have the relationship of CC 231<CC 232<CC 233<CC234. In some examples, CCs 231-234 which carry the scheduled transmissions 221-224 may be arranged according to an ascending order of their carrier indexes as carrier 330 as shown in FIG. 3. RB 341 denotes the lowest RB of the lowest carrier (e.g., CC 231) among the scheduled carriers in carrier 330. RB 342 denotes the highest RB of the highest carrier (e.g., CC 234) among the scheduled carriers in carrier 330. In some examples, RB 341 and RB 342 may be used as the starting RB and ending RB for numbering the RBs of carrier 330. For example, RBs on carrier 330 may be contiguously numbered as RB₀, RB₁, . . . , RB_{y-1} from RB 341 (RB₀) to RB 342 (RB_{y-1}), wherein y denotes the total number of RBs on CCs 231-234. The FDRA field of DCI format 211 may indicate the assigned RBs on carrier 330. The UE may determine the assigned RBs on CCs 231-234 for transmissions 221-224 according to the FDRA field and the resource allocation type, which will be described in details below.

Various methods may be applied to indicate the carriers scheduled by a DCI format.

In some embodiments, the scheduled carriers can be dynamically indicated from the plurality of carriers configured for the UE by the DCI format. For example, the scheduled carriers may be contiguously arranged in the plurality of configured carriers according to a predefined order (for example, carrier indexes or frequency locations of the scheduled carriers). In some examples, the DCI format may jointly indicate a first scheduled carrier of the contiguous scheduled carriers and the number of the contiguous scheduled carriers in the plurality of configured carriers. In some examples, the DCI format may indicate the number of the contiguous scheduled carriers in the plurality of configured carriers. The carrier where the DCI format is detected is assumed as the first scheduled carrier of the contiguous scheduled carriers. In some examples, the DCI format may indicate a carrier combination from a set of carrier combinations. The set of carrier combinations may be configured by the BS via, for example, RRC signaling. In other examples, the DCI format may indicate a bitmap with each bit corresponding to a respective carrier of the plurality of configured carriers.

In some embodiments, the scheduled carriers can be configured by a BS via, for example, RRC signaling. For example, the BS can configure a carrier combination from the plurality of configured carriers. Thus, the scheduled carriers are known to a UE before detecting the scheduling DCI.

From a UE's perspective, in the case that the scheduled carriers are dynamically indicated by the DCI format, a UE cannot know the payload size of the DCI before decoding the DCI, because the number of bits of the FDRA field may be variable according to the number of scheduled carriers and the number of RBs on each scheduled carrier. To avoid extra DCI blind detection, the payload size of the DCI format should be predetermined, for example, based on the maximum number of schedulable carriers by a single DCI and the maximum number of RBs on a carrier.

In the following context, N denotes the maximum number of carriers which can be scheduled by a single DCI, K denotes the maximum number of RBs on a carrier, and Y denotes the maximum total number of RBs which can be scheduled by the single DCI. In some examples, N may be configured by RRC signaling or predefined, for example, in a standard.

In some embodiments, Y=K*N. In some examples, K is equal to the predefined maximum number of RBs per carrier (e.g., 275). For example, when N=4 and K=275, Y=4×275=1100. In some examples, K is equal to the maximum number of RBs per carrier within the set of configured carriers. For example, assuming that n carriers (e.g., carrier #1-carrier #n) are configured for the UE and carrier #1 includes k₁ RBs, carrier #2 includes k₂ RBs, carrier #3 includes k₃ RBs, . . . , and carrier #n includes kₙ RBs, K=max{k₁, k₂, k₃, . . . , kₙ}. In some embodiments, Y=Z₁+Z₂+ . . . +Z_{N}, wherein Z₁, Z₂, . . . , Z_{N} are the N largest values among the set of {k₁, k₂, k₃, . . . , kₙ}.

The UE can determine the FDRA field size based on the above maximum total number of schedulable RBs (Y) and the configured or indicated resource allocation type(s) (e.g., resource allocation type 0, resource allocation type 1 or both as specified in 3GPP specifications).

For example, when only resource allocation type 0 is configured, it is assumed that N_{RBG} bits are required for indicating the FDRA field. The resource block assignment information includes a bitmap indicating the resource block groups (RBGs) that are allocated to the UE. An RBG is a set of consecutive RBs (e.g., virtual resource blocks (VRBs)) defined based on, for example, the following Table 1. It should be understood that Table 1 is only for illustrative purposes, and should not be construed as limiting the embodiments of the present disclosure.

TABLE 1
RBG size of P

| Y | Configuration 1 | Configuration 2 |
|---|---|---|
| 1-36 | 2 | 4 |
| 37-72 | 4 | 8 |
| 73-144 | 8 | 16 |
| 145-275 | 16 | 16 |
| 276-550 | 32 | 32 |
| 551-1100 | 64 | 64 |
| >1100 | 128 | 128 |

Since the number of all RBs on the scheduled carriers may exceed the limitation of the predefined maximum number of RBs per carrier (e.g., 275 RBs), entries with the value of Y greater than 275 are included to provide larger RBG sizes to control the number of required bits for the FDRA field.

The number of bits for the FDRA field is equal to the total number of RBGs (N_{RBG}) for all the RBs on the scheduled carrier, which is given by N_{RGB}==┌Y/P┐. According to the above Table 1, when the maximum total number of schedulable RBs (Y) is 280 (i.e., between “276-550”), the number of VRBs in a RBG is 32 in either the case of configuration 1 or configuration 2. The FDRA field may include 9 bits (i.e., ┌280/32┐.)

For example, when only resource allocation type 1 is configured, ┌log₂(Y(Y+1)/2┐ bits may be required for indicating the FDRA field.

For example, when both resource allocation type 0 and 1 are configured or when the resource allocation (e.g., indicated by the higher layer parameter “resourceAllocation”) is configured as dynamic switch (e.g., resourceAllocation=‘dynamicSwitch’), then max(┌log₂(Y(Y+1)/2)┐, N₃)+1 bits may be required for indicating the FDRA field. A specific bit (e.g., the most significant bit (MSB)) of the FDRA field may be used to indicate resource allocation type 0 or resource allocation type 1. For example, the bit value of “0” of the MSB indicates resource allocation type 0 and the bit value of “1” of the MSB indicates resource allocation type 1; or vice versa. For resource allocation type 0, specific N_{RBG} bits (e.g., N_{RBG} least significant bit (LSBs)) of the FDRA field may provide the resource allocation according to Table 1. For resource allocation type 1, specific ┌log₂(Y(Y+1)/2┐ bits (e.g., ┌log₂(Y(Y+1)/2┐ LSBs) of the FDRA field may provide the resource allocation according to the resource indication value (RIV) based indication.

At the UE side, the UE may blindly detect the DCI format based on the payload size determined according to the maximum number of RBs (e.g., Y) which can be scheduled by the DCI format and the resource allocation type. In response to the reception of the DCI format, the UE may determine the scheduled carriers, and determine the RBs assigned on the scheduled carriers based on the DCI format. For example, the UE may combine the scheduled carriers according to a predefined order (e.g., in an order of carrier indexes or carrier frequency locations), number all the RBs in the virtual carrier from a starting RB to an ending RB, and determine the assigned RBs according to the FDRA field and the resource allocation type. Once the assigned RBs are determined, the UE knows the distribution of assigned RBs on each scheduled carrier and receives PDSCHs or transmits PUSCHs on the scheduled carriers.

In the case that the scheduled carriers are configured by the BS, for example, as a carrier combination from the plurality of configured carriers, the scheduled carriers are known to a UE before detecting the scheduling DCI format. The UE can determine the payload size of the DCI format because the number of bits of the FDRA field can be predetermined according to the total number of RBs on the scheduled carriers (denoted as Y′) and the configured or indicated resource allocation type. For example, the UE can sum up the number of RBs on each of the scheduled carriers to determine the value of Y′, and determine the number of bits for the FDRA field of the DCI format based on Y′ and the resource allocation type according to a similar procedure as described above.

For example, when only resource allocation type 0 is configured, N′_{RGB}=┌Y′/P┐ bits may be required for indicating the FDRA field. For example, when only resource allocation type 1 is configured, ┌log₂(Y′(Y′+1)/2┐ bits may be required for indicating the FDRA field. For example, when both resource allocation type 0 and 1 are configured or when the resource allocation is configured as dynamic switch, max(┌log₂(Y′(Y′+1)/2)┐, N′_{RGB})+1 bits may be required for indicating the FDRA field.

The above embodiments can be applicable to scheduled carriers with the same or different SCS values. The above embodiments may apply to the scenario where all the scheduled carriers are configured with the same resource allocation type.

In some embodiments of the present disclosure, in the case that a single DCI format can schedule multiple carriers for downlink or uplink transmission, an indicator (e.g., a single FDRA field) of the DCI format indicates the RBs assigned on the scheduled carriers. The active bandwidth parts (BWPs) of the scheduled carriers may be virtually combined into a virtual active BWP according to a certain principle. The FDRA field in the DCI format indicates the assigned RBs on the virtual BWP.

For example, all RBs within the active BWPs on all the scheduled carriers are virtually combined and contiguously numbered among all the scheduled carriers with reference to a starting RB from the starting RB to an ending RB. From the UE's perspective, the frequency resources of the active BWPs on all the scheduled carriers are combined and can be logically regarded as a wider active BWP (e.g., virtual active BWP). The bandwidth of the virtual active BWP may exceed the limitation of the predefined maximum number of RBs per carrier (e.g., 275 RBs) due to the contiguous RB numbering for the active BWPs on all the scheduled carriers.

Various methods may be applied to combining the active BWPs on the scheduled carriers and numbering the RBs. For example, the active BWPs on the scheduled carriers may be combined according to a predefined order (for example, carrier indexes or frequency locations of the scheduled carriers).

In some embodiments, the active BWPs on the scheduled carriers may be combined into the virtual active BWP according to an ascending order of carrier indices of the corresponding scheduled carriers. In some examples, the lowest RB on the active BWP on the lowest carrier among the scheduled carriers in the virtual BWP may be used as the starting RB for numbering the RBs of the virtual BWP. The highest RB on the active BWP on the highest carrier among the scheduled carriers in the virtual BWP may be used as the ending RB for numbering the RBs of the virtual BWP. In some other examples, the highest RB on the active BWP on the highest carrier among the scheduled carriers in the virtual BWP may be used as the starting RB for numbering the RBs of the virtual BWP. The lowest RB on the active BWP on the lowest carrier among the scheduled carriers in the virtual BWP may be used as the ending RB for numbering the RBs of the virtual BWP.

In some embodiments, the active BWPs on the scheduled carriers may be combined into the virtual active BWP according to an ascending order of carrier frequency of the corresponding scheduled carriers. In some examples, the lowest RB on the active BWP on the lowest carrier among the scheduled carriers in the virtual BWP may be used as the starting RB for numbering the RBs of the virtual BWP. The highest RB on the active BWP on the highest carrier among the scheduled carriers in the virtual BWP may be used as the ending RB for numbering the RBs of the virtual BWP. In some other examples, the highest RB on the active BWP on the highest carrier among the scheduled carriers in the virtual BWP may be used as the starting RB for numbering the RBs of the virtual BWP. The lowest RB on the active BWP on the lowest carrier among the scheduled carriers in the virtual BWP may be used as the ending RB for numbering the RBs of the virtual BWP.

Various methods for indicating the carriers scheduled by a DCI format described above may also apply here.

For example, in some embodiments, the scheduled carriers can be dynamically indicated from the plurality of carriers configured for the UE by the DCI format. For example, the scheduled carriers may be contiguously arranged in the plurality of configured carriers according to a predefined order (for example, carrier indexes or frequency locations of the scheduled carriers). In some examples, the DCI format may indicate both the number of the contiguous scheduled carriers in the plurality of configured carriers and a first scheduled carrier of the contiguous scheduled carriers. In some examples, the DCI format may indicate the number of the contiguous scheduled carriers in the plurality of configured carriers. The carrier where the DCI format is detected is assumed as the first scheduled carrier of the contiguous scheduled carriers. In some examples, the DCI format may indicate a carrier combination from a set of carrier combinations. The set of carrier combinations may be configured by the BS via, for example, RRC signaling. In other examples, the DCI format may indicate a bitmap with each bit corresponding to a respective carrier of the plurality of configured carriers.

For example, in some embodiments, the scheduled carriers can be configured by a BS via, for example, RRC signaling. For example, the BS can configure a carrier combination from the plurality of configured carriers. Thus, the scheduled carriers are known to a UE before detecting the scheduling DCI.

From a UE's perspective, in the case that the scheduled carriers are dynamically indicated by the DCI format, a UE cannot know the payload size of the DCI before decoding the DCI. To avoid extra DCI blind detection, the payload size of the DCI format should be predetermined, for example, based on the maximum number of schedulable carriers by a single DCI and the maximum number of RBs on an active BWP.

In the following context, N still denotes the maximum number of carriers which can be scheduled by a single DCI, K1 denotes the maximum number of RBs on an active BWP, and Y1 denotes the maximum total number of RBs which can be scheduled by the single DCI. In some examples, N may be configured by RRC signaling or predefined, for example, in a standard.

In some embodiments, Y1=K1*N. In some examples, K1 is equal to the predefined maximum number of RBs per active BWP (e.g., 275). For example, when N=4 and K1=275, Y1=4×275=1100. In some examples, K1 is equal to the maximum number of RBs per active BWP within the set of configured carriers. For example, assuming that n′ carriers (e.g., carrier #1-carrier #n′) are configured for the UE and the current active BWP of carrier #1 includes k′₁ RBs, the current active BWP of carrier #2 includes k′₂ RBs, the current active BWP of carrier #3 includes k′₃ RBs, . . . , and the current active BWP of carrier #n′ includes k′ₙ, RBs, K1=max{k′₁, k′₂, k′₃, . . . , k′ₙ}. In some embodiments, Y1=Z′₁+Z′₂+ . . . +Z′_{N}, wherein Z′₁, Z′₂, . . . , Z_{N} are the N largest values among the set of {k′₁, k′₂, k′₃, . . . , k′_{n′}}.

The UE can determine the FDRA field size based on the above maximum total number of schedulable RBs (Y1) and the configured or indicated resource allocation type(s) (e.g., resource allocation type 0, resource allocation type 1 or both as specified in 3GPP specifications).

For example, when only resource allocation type 0 is configured, the FDRA field indicates a bitmap indicating the RBGs that are allocated to the UE. As described above, an RBG is a set of consecutive RBs (e.g., VRBs) defined based on, for example, the above Table 1. N1_{RGB}=┌Y1/P┐ bits may be required for indicating the FDRA field.

For example, when only resource allocation type 1 is configured, ┌log₂(Y1(Y1+1)/2┐ bits may be required for indicating the FDRA field.

For example, when both resource allocation type 0 and 1 are configured or when the resource allocation is configured as dynamic switch, then max(┌log₂(Y1(Y1+1)/2)┐, N1_{RGB})+1 bits may be required for indicating the FDRA field. A specific bit (e.g., the MSB) of the FDRA field may be used to indicate resource allocation type 0 or resource allocation type 1. For example, the bit value of “O” of the MSB indicates resource allocation type 0 and the bit value of “1” of the MSB indicates resource allocation type 1; or vice versa. For resource allocation type 0, specific N1_{RGB} bits (e.g., N_{RGB} LSBs) of the FDRA field may provide the resource allocation according to Table 1. For resource allocation type 1, specific ┌log₂(Y1(Y1+1)/2┐ bits (e.g., ┌log₂(Y1(Y1+1)/2┐ LSBs) of the FDRA field may provide the resource allocation according to the RIV based indication.

At the UE side, the UE may blindly detect the DCI format based on the payload size determined according to the maximum number of RBs which can be scheduled by the DCI format and the resource allocation type. In response to the reception of the DCI format, the UE may firstly determine the scheduled carriers, and determine the RBs assigned on the scheduled carriers based on the DCI format. For example, the UE may combine the scheduled carriers (or the active BWPs of the scheduled carriers) according to a predefined order (e.g., in an order of carrier indexes or carrier frequency locations), number all the RBs in the virtual BWP from a starting RB to an ending RB, and determine the assigned RBs according to the FDRA field and the resource allocation type. Once the assigned RBs are determined, the UE knows the distribution of assigned RBs on each scheduled carrier and receives PDSCHs or transmits PUSCHs on the scheduled carriers.

In the case that the scheduled carriers are configured by the BS, for example, as a carrier combination from the plurality of configured carriers, the scheduled carriers as well as the active BWPs of the scheduled carriers are known to a UE before detecting the scheduling DCI format. The UE can determine the payload size of the DCI format because the number of bits of the FDRA field can be predetermined according to the total number of RBs on the active BWPs of the scheduled carriers (denoted as Y1′) and the configured or indicated resource allocation type. For example, the UE can sum up the number of RBs on each active BWPs of the scheduled carriers to determine the value of Y1′, and determine the number of bits for the FDRA field of the DCI format based on Y1′ and the resource allocation type according to a similar procedure as described above.

For example, when only resource allocation type 0 is configured, N1′=┌Y1/P┐ bits may be required for indicating the FDRA field. For example, when only resource allocation type 1 is configured, flog ┌log₂(Y1′(Y1′+1)/2┐ bits may be required for indicating the FDRA field. For example, when both resource allocation type 0 and 1 are configured or when the resource allocation is configured as dynamic switch, max(┌log₂(Y1′(Y1′+1)/2┐), N1′_{RGB})+1 bits may be required for indicating the FDRA field.

The above embodiments can be applicable to scheduled carriers with the same or different SCS values. The above embodiments may apply to the scenario where all the scheduled carriers are configured with the same resource allocation type.

In some embodiments of the present disclosure, in the case that a single DCI format can schedule multiple carriers for downlink or uplink transmission, a list of FDRA patterns may be configured by RRC signaling or predefined, for example, in a standard. Each entry of the list may include: at least one of carrier indexes (also called “serving cell indexes”), BWP indicators, and FDRA indicators, or certain combinations of one or two of a carrier index, BWP indicator and FDRA indicator. An indicator in the DCI format scheduling multiple carriers may indicate one entry from the list. In response to the reception of the DCI format, the UE can know the scheduled carriers, BWP indicators, and assigned RBs on the respective scheduled carriers.

In some embodiments, each entry of the list may indicate at least one scheduled carrier, at least one BWP associated with the at least one scheduled carrier, and at least one FDRA indicator associated with the at least one scheduled carrier. For convenience, such FDRA pattern list is hereinafter referred to as “pattern list A”. In some examples, the number of scheduled carriers in an entry may be equal to the number of BWP indicators and the number of FDRA indicators in the corresponding entry. One example of pattern list A is shown in below Table 2a.

TABLE 2a
FDRA Pattern List

| Entry | Carrier indexes | BWP indicator | |
|---|---|---|---|
| index | (CIs) | (BWPI) | FDRA indicator |
| . . . | . . . | . . . | . . . |
| i | CI of 1^{st} | BWPI on 1^{st} | FDRA on 1^{st} |
| | scheduled carrier, | scheduled carrier, | scheduled carrier, |
| | CI of 2^{nd} | BWPI on 2^{nd} | FDRA on 2^{nd} |
| | scheduled carrier, | scheduled carrier, | scheduled carrier, |
| | . . . , | . . . , | . . . , |
| | CI of the Xᵢ^{th} | BWPI on the Xᵢ^{th} | FDRA on the Xᵢ^{th} |
| | scheduled carrier | scheduled carrier | scheduled carrier |
| i + 1 | CI of 1^{st} | BWPI on 1^{st} | FDRA on 1^{st} |
| | scheduled carrier, | scheduled carrier, | scheduled carrier, |
| | CI of 2^{nd} | BWPI on 2^{nd} | FDRA on 2^{nd} |
| | scheduled carrier, | scheduled carrier, | scheduled carrier, |
| | . . . , | . . . , | . . . , |
| | CI of the Xᵢ₊₁^{th} | BWPI on the Xᵢ₊₁^{th} | FDRA on the Xᵢ₊₁^{th} |
| | scheduled carrier | scheduled carrier | scheduled carrier |
| . . . | . . . | . . . | . . . |

In some embodiments, each entry of the list may indicate at least one combination of a scheduled carrier, a BWP associated with the scheduled carrier, and a FDRA indicator associated with the scheduled carrier. For convenience, such FDRA pattern list is hereinafter referred to as “pattern list B”. One example of pattern list B is shown in below Table 2b.

TABLE 2b
FDRA Pattern List

| Entry | |
|---|---|
| index | Frequency resource allocation patterns |
| . . . | . . . |
| i | {carrier index, BWP indicator, FDRA} of the 1^{st} scheduled |
| | carrier |
| | {carrier index, BWP indicator, FDRA} of the 2^{nd} scheduled |
| | carrier |
| | . . . |
| | {carrier index, BWP indicator, FDRA} of the Xᵢ^{th} |
| | scheduled carrier |
| i + 1 | {carrier index, BWP indicator, FDRA} of the 1^{st} scheduled |
| | carrier |
| | {carrier index, BWP indicator, FDRA} of the 2^{nd} scheduled |
| | carrier |
| | . . . |
| | {carrier index, BWP indicator, FDRA} of the Xᵢ₊₁^{th} |
| | scheduled carrier |
| . . . | . . . |

In some embodiments, each entry of the list may indicate at least one scheduled carrier and at least one BWP associated with the at least one scheduled carrier. For convenience, such FDRA pattern list is hereinafter referred to as “pattern list C”. One example of pattern list C is shown in below Table 2c. In some embodiments, each entry of the list may indicate at least one combination of a scheduled carrier and a BWP associated with the scheduled carrier. For convenience, such FDRA pattern list is hereinafter referred to as “pattern list D”. One example of pattern list D is shown in below Table 2d. The FDRA for each scheduled carrier may be separately indicated by a corresponding FDRA field in the scheduling DCI.

TABLE 2c
FDRA Pattern List

| Entry | | |
|---|---|---|
| index | Carrier indexes (CIs) | BWP indicator (BWPI) |
| . . . | . . . | . . . |
| i | CI of 1^{st} scheduled carrier, | BWPI on 1^{st} scheduled carrier, |
| | CI of 2^{nd} scheduled carrier, | BWPI on 2^{nd} scheduled carrier, |
| | . . . , | . . . , |
| | CI of the Xᵢ^{th} scheduled | BWPI on the Xᵢ^{th} scheduled |
| | carrier | carrier |
| i + 1 | CI of 1^{st} scheduled carrier, | BWPI on 1^{st} scheduled carrier, |
| | CI of 2^{nd} scheduled carrier, | BWPI on 2^{nd} scheduled carrier, |
| | . . . , | . . . , |
| | CI of the Xᵢ₊₁^{th} scheduled | BWPI on the Xᵢ₊₁^{th} scheduled |
| | carrier | carrier |
| . . . | . . . | . . . |

TABLE 2d
FDRA Pattern List

| Entry | |
|---|---|
| index | Frequency resource allocation patterns |
| . . . | . . . |
| i | {carrier index, BWP indicator} of the 1^{st} scheduled carrier |
| | {carrier index, BWP indicator} of the 2^{nd} scheduled carrier |
| | . . . |
| | {carrier index, BWP indicator} of the Xᵢ^{th} scheduled carrier |
| i + 1 | {carrier index, BWP indicator} of the 1^{st} scheduled carrier |
| | {carrier index, BWP indicator} of the 2^{nd} scheduled carrier |
| | . . . |
| | {carrier index, BWP indicator} of the Xᵢ₊₁^{th} scheduled |
| | carrier |
| . . . | . . . |

In some embodiments, each entry of the list may indicate at least one FDRA indicator associated with at least one scheduled carrier. For convenience, such FDRA pattern list is hereinafter referred to as “pattern list E”. One example of pattern list E is shown in below Table 2e. The carrier index and BWP indicator for each scheduled carrier may be indicated by a field(s) in the scheduling DCI format. For example, a DCI format may include separate fields for indicating the carrier indexes and the BWP indicators of the scheduled carriers.

TABLE 2e
FDRA Pattern List

| Entry | |
|---|---|
| index | Frequency resource allocation patterns |
| . . . | . . . |
| i | FDRA of the 1^{st} scheduled carrier |
| | FDRA of the 2^{nd} scheduled carrier |
| | . . . |
| | FDRA of the Xᵢ^{th} scheduled carrier |
| i + 1 | FDRA of the 1^{st} scheduled carrier |
| | FDRA of the 2^{nd} scheduled carrier |
| | . . . |
| | FDRA of the Xᵢ₊₁^{th} scheduled carrier |
| . . . | . . . |

In some embodiments, a specific scheduled carrier (e.g., the first one such as “1^{st} scheduled carrier” in Tables 2a-2d) in an entry of an FDRA pattern list (e.g., pattern lists A-D) may be the carrier where the scheduling DCI is detected. The carrier index of this scheduled carrier (e.g., “1^{st} scheduled carrier” in Tables 2a-2d) in the above FDRA pattern lists (e.g., pattern lists A-D) may be omitted. For example, Table 2c may be modified as the following Table 2c′. In some embodiments, in Table 2c′, the BWP indicator on the 1^{st} scheduled carrier may also be omitted when the active BWP where the scheduling DCI is received is assumed as the BWP on the 1^{st} scheduled carrier.

TABLE 2c′
FDRA Pattern List

| Entry | | |
|---|---|---|
| index | Carrier indexes (CIs) | BWP indicator (BWPI) |
| . . . | . . . | . . . |
| i | CI of 2^{nd} scheduled carrier, | BWPI on 1^{st} scheduled carrier, |
| | . . . , | BWPI on 2^{nd} scheduled carrier, |
| | CI of the Xᵢ^{th} scheduled | . . . , |
| | carrier | BWPI on the Xᵢ^{th} scheduled |
| | | carrier |
| i + 1 | CI of 2^{nd} scheduled carrier, | BWPI on 1^{st} scheduled carrier, |
| | . . . , | BWPI on 2^{nd} scheduled carrier, |
| | CI of the Xᵢ₊₁^{th} scheduled | . . . , |
| | carrier | BWPI on the Xᵢ₊₁^{th} scheduled |
| | | carrier |
| . . . | . . . | . . . |

In some examples, each entry in the above FDRA pattern lists (e.g., pattern lists A-E) may not include more scheduled carriers than the maximum number of carriers schedulable by a single DCI, which may be configured by RRC signaling or predefined, for example, in a standard. For example, assuming that N denotes the maximum number of carriers which can be scheduled by a single DCI, the number of FDRA indicators in each entry of pattern list E (e.g., Table 2e) may not be larger than N.

In some examples, the maximum number of carriers schedulable by a single DCI may be implicitly indicated by the number of scheduled carriers in each entry of a FDRA pattern list. In some examples, the maximum number of carriers schedulable by a single DCI may not be necessarily configured by separate RRC signaling.

In the above embodiments utilizing a FDRA pattern list, the payload size of the scheduling DCI may be determined based on the maximum number of required bits per entry among all the entries of the list. Once the list is configured to the UE or when the list is predefined, the UE can determine the number of required bits for each entry and assume the DCI payload size based on the maximum number of required bits per entry. In some embodiments, the payload size of the scheduling DCI may be determined based on the number of entries of the corresponding FDRA pattern list.

For example, taking pattern list A and pattern list B as an example, the payload size of the DCI format may be determined based on the number of entries in the corresponding FDRA pattern list. For example, assuming that 16 entries are configured in pattern list A or B with each entry including, for example, up to 8 combinations for a maximum of 8 carriers schedulable by a DCI format, the DCI format may include an indicator of at least 4 bits (log₂ 16) for indicating an entry from the list. Since each entry includes FDRA information, there is no FDRA field in the DCI format.

Taking pattern list C and pattern list D as an example, in some embodiments, the payload size of the DCI format may be determined based on the number of entries in the FDRA pattern list, the maximum number of scheduled carriers indicated in an entry, and the maximum number of RBs per carrier among the plurality of carriers configured for the UE (e.g., a carrier of the plurality of configured carriers with the largest RB number).

In some embodiments, the payload size of the DCI format may be determined based on the number of entries in the FDRA pattern list, the maximum number of scheduled carriers indicated in an entry, and the maximum number of RBs per carrier among the carriers indicated in the pattern list (e.g., a carrier indicated in an entry of the pattern list with the largest RB number).

In some embodiments, the payload size of the DCI format may be determined based on the number of entries in the FDRA pattern list, the maximum number of scheduled carriers indicated in an entry, and the maximum number of RBs per BWP as indicated by the BWP indicator among the carriers indicated in the pattern list (e.g., for each “carrier and BWP” combination in each entry of the pattern list, determining a BWP based on the corresponding “carrier and BWP” combination having the largest RB number).

For example, for each scheduled carrier, the DCI format may include a corresponding FDRA field. The size of a FDRA field may be determined based on the maximum number of RBs per carrier among the plurality of carriers configured for the UE, or the maximum number of RBs per carrier among the carriers indicated in the pattern list, or the maximum number of RBs per BWP as indicated by the BWP indicator among the carriers indicated in the pattern list. The maximum size of all FDRA fields may be based on the maximum number of scheduled carriers indicated in an entry (e.g., the maximum number of “carrier and BWP” combinations in pattern list D) and the determined size of the FDRA field (e.g., by multiplying the two values). The payload size of the DCI format may be determined based on the maximum size of all FDRA fields and the number of entries in the FDRA pattern list (e.g., for the indicator indicating an entry from the list).

Taking pattern list E as an example, the payload size of the DCI format may be determined based on the number of entries in the FDRA pattern list and the maximum number of FDRA indicators indicated in an entry. For example, for each scheduled carrier, the DCI format may include a corresponding carrier index field (e.g., p bits) and a corresponding BWP indicator field (e.g., q bits). Assuming that 16 entries are configured in pattern list E with each entry including, for example, up to 8 FDRA indicators for a maximum of 8 carriers schedulable by a DCI format, the payload size of the DCI format may be determined based on: (p+q)×8 bits (e.g., for carrier index fields and BWP indicator fields) and 4 bits (log₂ 16) (e.g., for the indicator indicating an entry from the list).

The above embodiments utilizing a FDRA pattern list can be applicable to scheduled carriers with the same or different SCS values. The above embodiments utilizing a FDRA pattern list may apply to the scenario where different scheduled carriers are configured with the same or different resource allocation types.

In some embodiments of the present disclosure, in the case that a single DCI format can schedule multiple carriers for downlink or uplink transmission, one or more indicators (e.g., one or more FDRA fields) of the DCI format may indicate the RBs assigned on the scheduled carriers. For example, as will be described below, the number of the FDRA fields may be dependent on the number of frequency bands or frequency ranges of the plurality of configured carriers for a UE.

In some embodiments, the carriers scheduled by a DCI format can be dynamically indicated from the plurality of configured carriers for the UE by the DCI format. For instance, the scheduled carriers may be contiguously arranged in the plurality of configured carriers according to a predefined order (for example, carrier indexes or frequency locations of the scheduled carriers). In some examples, the DCI format may jointly indicate the number of the contiguous scheduled carriers in the plurality of configured carriers and a first scheduled carrier of the contiguous scheduled carriers. In some examples, the DCI format may indicate the number of the contiguous scheduled carriers in the plurality of configured carriers. The carrier where the DCI format is detected is assumed as the first scheduled carrier. In some examples, the DCI format may indicate a carrier combination from a set of carrier combinations. The set of carrier combinations may be configured by the BS via, for example, RRC signaling. In some examples, the DCI format may indicate a bitmap with each bit corresponding to a respective carrier of the plurality of configured carriers.

In some embodiments, the scheduled carriers can be configured by a BS via, for example, RRC signaling. For example, the BS can configure a carrier combination from the plurality of configured carriers. Thus, the scheduled carriers are known to a UE before detecting the scheduling DCI.

In some embodiments, the number of FDRA fields in the DCI format may be dependent on the number of frequency bands for the configured carriers of the UE. For the configured carriers on the same frequency band, such as intra-band carrier aggregation, the same FDRA field is shared among the carriers on the frequency band. That is, the same FDRA is applied to the scheduled carriers within the same frequency band. Same resource allocation type is configured for the carriers in the same frequency band. For the configured carriers on different frequency bands, such as inter-band carrier aggregation, multiple FDRA fields are required with each FDRA field corresponding to a corresponding frequency band. Separate resource allocation types can be configured for the carriers in different frequency bands.

Based on the configured carriers by RRC signaling, a UE can determine the number of frequency bands for the configured carriers and determine the number of FDRA fields in a scheduling DCI format based on the number of frequency bands for the configured carriers. For each FDRA field in the DCI format, the number of required bits may be set to the maximum number of required bits for each carrier among the multiple carriers in the same frequency band.

For example, in the case that the scheduled carriers are dynamically indicated by the DCI format, the payload size of the DCI format and the size of a FDRA field in the DCI format may be dependent on a maximum number of RBs per carrier among carriers of the plurality of configured carriers in the same frequency band.

For example, in the case that the scheduled carriers are configured by the BS, the scheduled carriers are known to a UE before detecting the scheduling DCI format. The payload size of the DCI format and the size of a FDRA field in the DCI format may be dependent on a maximum number of RBs per carrier among carriers of the scheduled carriers in the same frequency band.

At the UE side, in response to the reception of the plurality of configured carriers, the UE can determine the number of frequency bands for these configured carriers, and thus would know the number of FDRA fields in a DCI format. The UE can then determine the number of required bits for the FDRA field corresponding to each frequency band, and determine the payload size of the scheduling DCI based on the number of frequency bands and the maximum number of bits for the FDRA field corresponding to each frequency band.

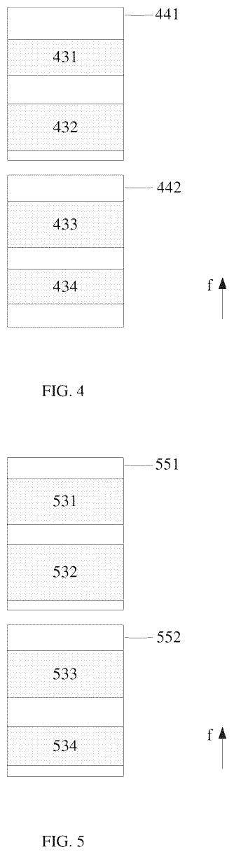

For example, referring to FIG. 4, a UE may be configured with a plurality of CCs (e.g., CCs 431-434 in FIG. 4). The SCS values of CCs 431-434 may be the same or different. CC 431 and CC 432 are within frequency band 441 and CC 433 and CC 434 are within frequency band 442. CC 431 and CC 432 within the same frequency band may be configured with the same resource allocation type, and CC 433 and CC 434 within the same frequency band may be configured with the same resource allocation type. The resource allocation type for CC 431 and CC 432 may be different or the same as that for CC 433 and CC 434.

The UE can determine that there are two FDRA fields included in a DCI format with each FDRA field corresponding to a frequency band. It is assumed that FDRA field #1 and FDRA field #2 correspond to frequency band 441 and frequency band 442, respectively. It is further assumed that the number of RBs on CC 432 is greater than the number of RBs on CC 431 and the number of RBs on CC 433 is greater than the number of RBs on CC 434.

In some examples, the carriers scheduled by a DCI format may be dynamically indicated by the DCI format. For example, the DCI format may schedule transmissions on CCs 431, 433, and 434. The UE may determine the payload size of the DCI format and the size of a FDRA field (e.g., FDRA field #1 or FDRA field #2) based on a maximum number of RBs per carrier among carriers of the plurality of configured carriers in the same frequency band. For example, since the number of RBs on CC 432 is greater than the number of RBs on CC 431 and the number of RBs on CC 433 is greater than the number of RBs on CC 434, the UE may determine the size of FDRA field #1 based on the number of RBs on CC 432 and determine the size of FDRA field #2 based on the number of RBs on CC 433.

For example, the size of FDRA field #1 may be determined based on the number of RBs on CC 432 (denoted as “Y2”) and the resource allocation type for CC 431 and CC 432. For example, when only resource allocation type 0 is configured, the size of FDRA field #1 can be determined by N2_{RGB}=┌Y2/P┐. When only resource allocation type 1 is configured, the size of FDRA field #1 can be determined by ┌log₂(Y2(Y2+1)/2┐. When both resource allocation type 0 and 1 are configured or when the resource allocation is configured as dynamic switch, the size of FDRA field #1 can be determined by max(┌log₂(Y2(Y2+1)/2)┐, N2_{RGB})+1.

In some examples, the scheduled carriers may be configured by the BS. The UE may determine the payload size of the DCI format and the size of a FDRA field (e.g., FDRA field #1 or FDRA field #2) based on a maximum number of RBs per carrier among carriers of the scheduled carriers in the same frequency band. For example, assuming that the BS configures that transmissions on CCs 431, 433, and 434 will be scheduled by a DCI format, the UE may determine the size of FDRA field #1 based on the number of RBs on CC 431 and determine the size of FDRA field #2 based on the number of RBs on CC 433. For example, the methods for determining the size of a FDRA field described above may also apply here.

In some embodiments, the number of FDRA fields in the DCI format may be dependent on the number of frequency ranges for the configured carriers of the UE. The frequency ranges may include FR1 and FR2 or FR1, FR2-1, and FR2-2. FR1 may include a frequency range of 410 MHz-7125 MHz. FR2 may include a frequency range of 24250 MHz-52600 MHz. FR2-1 may include a frequency range of 24250 MHz-52600 MHz. FR2-2 may include a frequency range of 52600 MHz-71000 MHz. For the configured carriers on the same frequency range, the same FDRA field is shared among the carriers on the frequency range. That is, the same FDRA is applied to the scheduled carriers within the same frequency range. Same resource allocation type is configured for the carriers in the same frequency range. For the configured carriers on different frequency ranges, multiple FDRA fields are required with each FDRA field corresponding to a corresponding frequency range. Separate resource allocation types can be configured for the carriers in different frequency ranges.

Based on the configured carriers by RRC signaling, a UE can determine the number of frequency ranges for the configured carriers and determine the number of FDRA fields in a scheduling DCI format based on the number of frequency ranges for the configured carriers. For each FDRA field in the DCI format, the number of required bits may be set to the maximum number of required bits for each carrier among the multiple carriers in the same frequency range.

For example, in the case that the scheduled carriers are dynamically indicated by the DCI format, the payload size of the DCI format and the size of a FDRA field in the DCI format may be dependent on a maximum number of RBs per carrier among carriers of the plurality of configured carriers in the same frequency range.

For example, in the case that the scheduled carriers are configured by the BS, the scheduled carriers are known to a UE before detecting the scheduling DCI format. The payload size of the DCI format and the size of a FDRA field in the DCI format may be dependent on a maximum number of RBs per carrier among carriers of the scheduled carriers in the same frequency range.

At the UE side, in response to the reception of the plurality of configured carriers, the UE can determine the number of frequency ranges for these configured carriers, and thus would know the number of FDRA fields in a DCI format. The UE can then determine the number of required bits for the FDRA field corresponding to each frequency range, and determine the payload size of the scheduling DCI based on the number of frequency ranges and the maximum number of bits for the FDRA field corresponding to each frequency range.

For example, referring to FIG. 5, a UE may be configured with a plurality of CCs (e.g., CCs 531-534 in FIG. 5). CC 531 and CC 532 are within frequency range 551 and CC 533 and CC 534 are within frequency range 552. CC 531 and CC 532 within the same frequency range may be configured with the same resource allocation type, and CC 533 and CC 534 within the same frequency range may be configured with the same resource allocation type. The resource allocation type for CC 531 and CC 532 may be different or the same as that for CC 533 and CC 534.

The UE can determine that there are two FDRA fields included in a DCI format with each FDRA field corresponding to a frequency range. Assuming that FDRA field #A1 and FDRA field #A2 respectively correspond to frequency range 551 and frequency range 552. It is assumed that the number of RBs on CC 532 is greater than the number of RBs on CC 531 and the number of RBs on CC 533 is greater than the number of RBs on CC 534.

In some examples, the carriers scheduled by a DCI format may be dynamically indicated by the DCI format. For example, the DCI format may schedule transmissions on CCs 531 and 533. The UE may determine the payload size of the DCI format and the size of a FDRA field (e.g., FDRA field #A1 or FDRA field #A2) based on a maximum number of RBs per carrier among carriers of the plurality of configured carriers in the same frequency range. For example, since the number of RBs on CC 532 is greater than the number of RBs on CC 531 and the number of RBs on CC 533 is greater than the number of RBs on CC 534, the UE may determine the size of FDRA field #A1 based on the number of RBs on CC 532 and determine the size of FDRA field #A2 based on the number of RBs on CC 533. For example, the methods for determining the size of a FDRA field described above may also apply here.

In some examples, the scheduled carriers may be configured by the BS. The UE may determine the payload size of the DCI format and the size of a FDRA field (e.g., FDRA field #A1 or FDRA field #A2) based on a maximum number of RBs per carrier among carriers of the scheduled carriers in the same frequency range. For example, assuming that the BS configures that transmissions on CCs 531, 533, and 534 will be scheduled by a DCI format, the UE may determine the size of FDRA field #A1 based on the number of RBs on CC 531 and determine the size of FDRA field #A2 based on the number of RBs on CC 533. For example, the methods for determining the size of a FDRA field described above may also apply here.

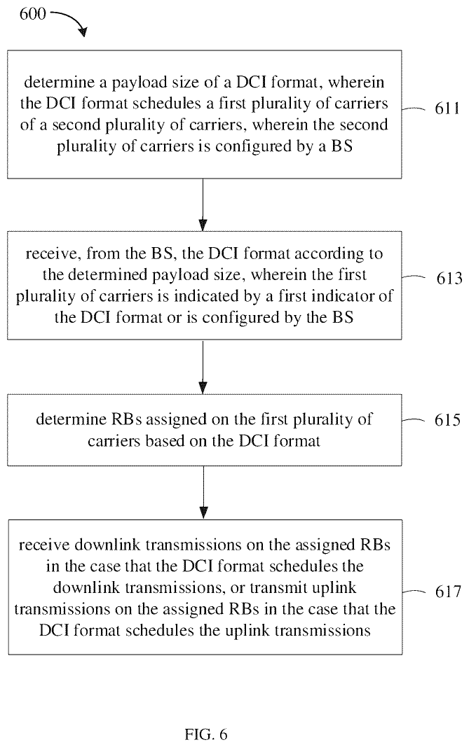

FIG. 6 illustrates a flow chart of an exemplary procedure 600 for wireless communications in accordance with some embodiments of the present disclosure. Details described in all of the foregoing embodiments of the present disclosure are applicable for the embodiments shown in FIG. 6. In some examples, the procedure may be performed by a UE, for example, UE 101 in FIG. 1.

Referring to FIG. 6, in operation 611, a UE may determine a payload size of a DCI format, wherein the DCI format schedules a first plurality of carriers of a second plurality of carriers, wherein the second plurality of carriers is configured by a BS.

In operation 613, the UE may receive, from the BS, the DCI format according to the determined payload size, wherein the first plurality of carriers is indicated by a first indicator of the DCI format or is configured by the BS. In operation 615, the UE may determine RBs assigned on the first plurality of carriers based on the DCI format.

In operation 617, the UE may receive downlink transmissions on the assigned RBs in the case that the DCI format schedules the downlink transmissions, or transmit uplink transmissions on the assigned RBs in the case that the DCI format schedules the uplink transmissions.

In some embodiments, the first indicator may indicate: a first scheduled carrier of the first plurality of carriers and the number of the first plurality of carriers, wherein the first plurality of carriers are contiguously arranged in the second plurality of carriers according to a predefined order; the number of the first plurality of carriers, wherein the first plurality of carriers are contiguously arranged in the second plurality of carriers according to a predefined order and the DCI format is received on a first scheduled carrier of the first plurality of carriers; a carrier combination from a set of carrier combinations; or a bitmap with each bit corresponding to a corresponding carrier of the second plurality of carriers.

In some embodiments, determining the assigned RBs on each of the first plurality of carriers may include: combining the first plurality of carriers into a virtual carrier according to a predefined order; and determining the assigned RBs on the virtual carrier according to a second indicator in the DCI format and a resource allocation type associated with the first plurality of carriers.

In some embodiments, determining the assigned RBs on each of the first plurality of carriers may include: combining active bandwidth parts (BWPs) of the first plurality of carriers into a virtual BWP according to a predefined order; and determining the assigned RBs on the virtual BWP according to a second indicator in the DCI format and a resource allocation type associated with the first plurality of carriers.

In some embodiments, the predefined order may be based on carrier indexes or frequency locations of the first plurality of carriers.

In some embodiments, a field size of the second indicator may be dependent on a resource allocation type associated with the first plurality of carriers and one of a maximum total number of RBs schedulable by the DCI format, a total number of RBs on the first plurality of carriers, or a total number of RBs on the active bandwidth parts (BWPs) of the first plurality of carriers.

In some embodiments, in the case that the first plurality of carriers is indicated by the first indicator, the payload size of the DCI format may be determined based on a maximum total number of RBs schedulable by the DCI format.

In some embodiments, the maximum total number of RBs may be determined based on one of the following: N and a predefined maximum number of RBs per carrier (e.g., 275 RBs); N and a maximum number of RBs per carrier among the second plurality of carriers; or the total number of RBs of N carriers among the second plurality of carriers, where the N carriers include the largest RB numbers among the second plurality of carriers. N denotes the maximum number of carriers schedulable by the DCI format.

In some embodiments, the maximum total number of RBs may be determined based on one of the following: N and a predefined maximum number of RBs per carrier; N and a maximum number of RBs per active bandwidth part (BWP) per carrier among the second plurality of carriers; or the total number of RBs of active BWPs of N carriers among the second plurality of carriers, where the active BWPs of N carriers include the largest RB numbers among the active BWPs of the second plurality of carriers. N denotes the maximum number of carriers schedulable by the DCI format.

In some embodiments, in the case that the first plurality of carriers is configured by the BS, the payload size of the DCI format may be determined based on the total number of RBs on the first plurality of carriers, or the total number of RBs on the active bandwidth parts (BWPs) of the first plurality of carriers.

In some embodiments, the UE may receive a frequency domain resource assignment (FDRA) pattern list from the BS.

In some examples, the FDRA pattern list may include at least one entry, each of which may indicate one of the following: at least one scheduled carrier, at least one bandwidth part (BWP) associated with the at least one scheduled carrier, and at least one FDRA indicator associated with the at least one scheduled carrier; and at least one combination of a scheduled carrier, a BWP associated with the scheduled carrier, and a FDRA indicator associated with the scheduled carrier. The first indicator may indicate an entry from the FDRA pattern list. The payload size of the DCI format may be determined based on the number of entries in the FDRA pattern list

In some examples, the FDRA pattern list may include at least one entry, each of which may indicate one of the following: at least one scheduled carrier and at least one bandwidth part (BWP) associated with the at least one scheduled carrier; and at least one combination of a scheduled carrier and a BWP associated with the scheduled carrier. The first indicator may indicate a first entry of the at least one entry. The DCI format may further include a FDRA indicator corresponding to each scheduled carrier indicated by the first entry. The payload size of the DCI format may be determined based on the number of entries in the FDRA pattern list, the maximum number of scheduled carriers indicated in an entry, and the maximum number of RBs per carrier among the second plurality of carriers.

In some examples, the FDRA pattern list may include at least one entry, each of which may indicate at least one FDRA indicator associated with at least one scheduled carrier. The DCI format may include a second indicator indicating a first entry of the at least one entry. The first entry may indicate a set of FDRA indicators associated with the first plurality of carriers indicated by the first indicator. The DCI format may further include a third indicator indicating a set of bandwidth parts (BWPs) associated with the first plurality of carriers. The payload size of the DCI format may be determined based on the number of entries in the FDRA pattern list and the maximum number of FDRA indicators indicated in an entry.

In some embodiments, the DCI format may include at least one second indicator for frequency domain resource assignment. The number of the at least one second indicator may be dependent on the number of frequency bands or frequency ranges of the second plurality of carriers. In some examples, the payload size of the DCI format and a field size of the second indicator may be dependent on a maximum number of RBs per carrier among carriers of the second plurality of carriers in the same frequency band or frequency range, or a maximum number of RBs per carrier among carriers of the first plurality of carriers in the same frequency band or frequency range. In some examples, the same second indicator may be applied to carriers of the first plurality of carriers within the same frequency band or frequency range.

It should be appreciated by persons skilled in the art that the sequence of the operations in exemplary procedure 600 may be changed and some of the operations in exemplary procedure 600 may be eliminated or modified, without departing from the spirit and scope of the disclosure.

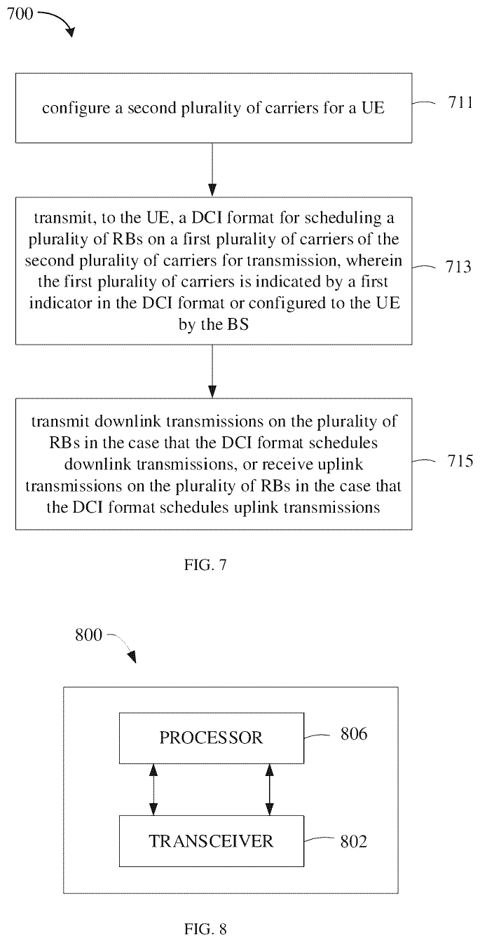

FIG. 7 illustrates a flow chart of an exemplary procedure 700 for wireless communications in accordance with some embodiments of the present disclosure. Details described in all of the foregoing embodiments of the present disclosure are applicable for the embodiments shown in FIG. 7. In some examples, the procedure may be performed by a BS, for example, BS 102 in FIG. 1.

Referring to FIG. 7, in operation 711, a BS may configure a second plurality of carriers for a UE. In operation 713, the BS may transmit, to the UE, a DCI format for scheduling a plurality of RBs on a first plurality of carriers of the second plurality of carriers for transmission, wherein the first plurality of carriers is indicated by a first indicator in the DCI format or configured to the UE by the BS.

In operation 715, the BS may transmit downlink transmissions on the plurality of RBs in the case that the DCI format schedules downlink transmissions, or receive uplink transmissions on the plurality of RBs in the case that the DCI format schedules uplink transmissions.

In some embodiments, the first indicator may indicate: a specific (first) carrier of the first plurality of carriers and the number of the first plurality of carriers, wherein the first plurality of carriers are contiguously arranged in the second plurality of carriers according to a predefined order; the number of the first plurality of carriers, wherein the first plurality of carriers are contiguously arranged in the second plurality of carriers according to a predefined order and the DCI format is received on a specific (first) carrier of the first plurality of carriers; a carrier combination from a set of carrier combinations; or a bitmap with each bit corresponding to a corresponding carrier of the second plurality of carriers.

In some embodiments, the BS may further: combine the first plurality of carriers into a virtual carrier according to a predefined order; and determine the plurality of RBs on the virtual carrier according to a second indicator in the DCI format and a resource allocation type associated with the first plurality of carriers.

In some embodiments, the BS may further: combine active bandwidth parts (BWPs) of the first plurality of carriers into a virtual BWP according to a predefined order; and determine the plurality of RBs on the virtual BWP according to a second indicator in the DCI format and a resource allocation type associated with the first plurality of carriers.

In some embodiments, the predefined order may be based on carrier indexes or frequency locations of the first plurality of carriers.

In some embodiments, a field size of the second indicator may be dependent on a resource allocation type associated with the first plurality of carriers and one of a maximum total number of RBs schedulable by the DCI format, a total number of RBs on the first plurality of carriers, or a total number of RBs on the active bandwidth parts (BWPs) of the first plurality of carriers.

In some embodiments, in the case that the first plurality of carriers is indicated by the first indicator, the payload size of the DCI format may be determined based on a maximum total number of RBs schedulable by the DCI format.

In some embodiments, the maximum total number of RBs may be determined based on one of the following: N and a predefined maximum number of RBs per carrier (e.g., 275 RBs); N and a maximum number of RBs per carrier among the second plurality of carriers; or the total number of RBs of N carriers among the second plurality of carriers, where the N carriers include the largest RB numbers among the second plurality of carriers. N is the maximum number of carriers schedulable by the DCI format.

In some embodiments, the maximum total number of RBs may be determined based on one of the following: N and a predefined maximum number of RBs per carrier; N and a maximum number of RBs per active bandwidth part (BWP) per carrier among the second plurality of carriers; or the total number of RBs of active BWPs of N carriers among the second plurality of carriers, where the active BWPs of N carriers include the largest RB numbers among the active BWPs of the second plurality of carriers. N is the maximum number of carriers schedulable by the DCI format.

In some embodiments, in the case that the first plurality of carriers is configured by the BS, the payload size of the DCI format is determined based on the total number of RBs on the first plurality of carriers, or the total number of RBs on the active bandwidth parts (BWPs) of the first plurality of carriers.

In some embodiments, the BS may transmit a frequency domain resource assignment (FDRA) pattern list to the UE.

In some examples, the FDRA pattern list may include at least one entry, each of which may indicate one of the following: at least one scheduled carrier, at least one bandwidth part (BWP) associated with the at least one scheduled carrier, and at least one FDRA indicator associated with the at least one scheduled carrier; and at least one combination of a scheduled carrier, a BWP associated with the scheduled carrier, and a FDRA indicator associated with the scheduled carrier; and wherein the first indicator may indicate an entry from the FDRA pattern list. The payload size of the DCI format may be determined based on the number of entries in the FDRA pattern list.

In some examples, the FDRA pattern list may include at least one entry, each of which may indicate one of the following: at least one scheduled carrier and at least one bandwidth part (BWP) associated with the at least one scheduled carrier; and at least one combination of a scheduled carrier and a BWP associated with the scheduled carrier. The first indicator may indicate a first entry of the at least one entry. The DCI format may further include a FDRA indicator corresponding to each scheduled carrier indicated by the first entry. The payload size of the DCI format may be determined based on the number of entries in the FDRA pattern list, the maximum number of scheduled carriers indicated in an entry, and the maximum number of RBs per carrier among the second plurality of carriers.

In some examples, the FDRA pattern list may include at least one entry, each of which may indicate at least one FDRA indicator associated with at least one scheduled carrier. The DCI format may include a second indicator indicating a first entry of the at least one entry. The first entry may indicate a set of FDRA indicators associated with the first plurality of carriers indicated by the first indicator. The DCI format may further include a third indicator indicating a set of bandwidth parts (BWPs) associated with the first plurality of carriers. The payload size of the DCI format may be determined based on the number of entries in the FDRA pattern list and the maximum number of FDRA indicators indicated in an entry.

In some embodiments, the DCI format may include at least one second indicator for frequency domain resource assignment. The number of the at least one second indicator may be dependent on the number of frequency bands or frequency ranges of the second plurality of carriers. In some examples, the payload size of the DCI format and a field size of the second indicator may be dependent on a maximum number of RBs per carrier among carriers of the second plurality of carriers in the same frequency band or frequency range, or a maximum number of RBs per carrier among carriers of the first plurality of carriers in the same frequency band or frequency range. In some examples, the same second indicator may be applied to carriers of the first plurality of carriers within the same frequency band or frequency range.

It should be appreciated by persons skilled in the art that the sequence of the operations in exemplary procedure 700 may be changed and some of the operations in exemplary procedure 700 may be eliminated or modified, without departing from the spirit and scope of the disclosure.

FIG. 8 illustrates a block diagram of an exemplary apparatus 800 according to some embodiments of the present disclosure. As shown in FIG. 8, the apparatus 800 may include at least one processor 806 and at least one transceiver 802 coupled to the processor 806. The apparatus 800 may be a UE or a BS.

Although in this figure, elements such as the at least one transceiver 802 and processor 806 are described in the singular, the plural is contemplated unless a limitation to the singular is explicitly stated. In some embodiments of the present application, the transceiver 802 may be divided into two devices, such as a receiving circuitry and a transmitting circuitry. In some embodiments of the present application, the apparatus 800 may further include an input device, a memory, and/or other components.

In some embodiments of the present application, the apparatus 800 may be a UE. The transceiver 802 and the processor 806 may interact with each other so as to perform the operations with respect to the UE described in FIGS. 1-7. In some embodiments of the present application, the apparatus 800 may be a BS. The transceiver 802 and the processor 806 may interact with each other so as to perform the operations with respect to the BS described in FIGS. 1-7.

In some embodiments of the present application, the apparatus 800 may further include at least one non-transitory computer-readable medium.

For example, in some embodiments of the present disclosure, the non-transitory computer-readable medium may have stored thereon computer-executable instructions to cause the processor 806 to implement the method with respect to the UE as described above. For example, the computer-executable instructions, when executed, cause the processor 806 interacting with transceiver 802 to perform the operations with respect to the UE described in FIGS. 1-7.

In some embodiments of the present disclosure, the non-transitory computer-readable medium may have stored thereon computer-executable instructions to cause the processor 806 to implement the method with respect to the BS as described above. For example, the computer-executable instructions, when executed, cause the processor 806 interacting with transceiver 802 to perform the operations with respect to the BS described in FIGS. 1-7.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

What is claimed is:

1. A user equipment (UE), comprising:
at least one memory; and
at least one processor coupled with the at least one memory and configured to cause the UE to:
determine a payload size of a downlink control information (DCI) format, wherein the DCI format schedules a first plurality of carriers of a second plurality of carriers;
receive the DCI format according to the determined payload size, wherein the first plurality of carriers is indicated by a first indicator of the DCI format or is configured by a base station;
determine resource blocks (RBs) assigned on the first plurality of carriers based on the DCI format; and
receive downlink transmissions on the assigned RBs based at least in part on the DCI format scheduling the downlink transmissions, or transmit uplink transmissions on the assigned RBs based at least in part on the DCI format scheduling the uplink transmissions.

2. The UE of claim 1, wherein the first indicator indicates one or more of:
a first carrier of the first plurality of carriers and a number of the first plurality of carriers, wherein the first plurality of carriers are contiguously arranged in the second plurality of carriers according to a predefined order;
the number of the first plurality of carriers, wherein the first plurality of carriers are contiguously arranged in the second plurality of carriers according to a predefined order and the DCI format is received on a first carrier of the first plurality of carriers;
a carrier combination from a set of carrier combinations; or
a bitmap with each bit corresponding to a corresponding carrier of the second plurality of carriers.

3. The UE of claim 1, wherein to determine the assigned RBs on each of the first plurality of carriers, the at least one processor is configured to cause the UE to:
combine the first plurality of carriers into a virtual carrier according to a predefined order; and
determine the assigned RBs on the virtual carrier according to a second indicator in the DCI format and a resource allocation type associated with the first plurality of carriers.

4. The UE of claim 1, wherein to determine the assigned RBs on each of the first plurality of carriers, the at least one processor is configured to cause the UE to:
combine active bandwidth parts (BWPs) of the first plurality of carriers into a virtual BWP according to a predefined order; and
determine the assigned RBs on the virtual BWP according to a second indicator in the DCI format and a resource allocation type associated with the first plurality of carriers.

5. The UE of claim 3, wherein a field size of the second indicator is based at least in part on a resource allocation type associated with the first plurality of carriers and one of a maximum total number of RBs schedulable by the DCI format, a total number of RBs on the first plurality of carriers, or a total number of RBs on active bandwidth parts (BWPs) of the first plurality of carriers.

6. The UE of claim 1, wherein based at least in part on the first plurality of carriers is-being indicated by the first indicator, the payload size of the DCI format is determined based on a maximum total number of RBs schedulable by the DCI format.

7. The UE of claim 6, wherein N is a maximum number of carriers schedulable by the DCI format, and wherein the maximum total number of RBs is determined based on at least one of:
N and a predefined maximum number of RBs per carrier;
N and a maximum number of RBs per carrier among the second plurality of carriers; or
the total number of RBs of N carriers among the second plurality of carriers, and the N carriers include a largest RB numbers among the second plurality of carriers.

8. The UE of claim 6, wherein N is a maximum number of carriers schedulable by the DCI format, and wherein the maximum total number of RBs is determined based on at least one of:
N and a predefined maximum number of RBs per carrier;
N and a maximum number of RBs per active bandwidth part (BWP) per carrier among the second plurality of carriers; or
the total number of RBs of active BWPs of N carriers among the second plurality of carriers, and the active BWPs of N carriers include a largest RB numbers among the active BWPs of the second plurality of carriers.

9. The UE of claim 1, wherein the at least one processor is configured to cause the UE to receive a frequency domain resource assignment (FDRA) pattern list from the base station.

10. The UE of claim 9, wherein the FDRA pattern list includes at least one entry, each of which indicates at least one of:
at least one scheduled carrier, at least one bandwidth part (BWP) associated with the at least one scheduled carrier, and at least one FDRA indicator associated with the at least one scheduled carrier; or
at least one combination of a scheduled carrier, a BWP associated with the scheduled carrier, and a FDRA indicator associated with the scheduled carrier;
wherein the first indicator indicates an entry from the FDRA pattern list.

11. The UE of claim 9, wherein the FDRA pattern list includes at least one entry comprising at least one of:
at least one scheduled carrier and at least one bandwidth part (BWP) associated with the at least one scheduled carrier; or
at least one combination of a scheduled carrier and a BWP associated with the scheduled carrier.

12. The UE of claim 9, wherein the FDRA pattern list includes at least one entry comprising at least one FDRA indicator associated with at least one scheduled carrier.

13. The UE of claim 1, wherein the DCI format includes at least one second indicator for frequency domain resource assignment, and a number of the at least one second indicator is based at least in part on a number of frequency bands or frequency ranges of the second plurality of carriers.

14. A base station for wireless communication, comprising:
at least one memory; and
at least one processor coupled with the at least one memory and configured to cause the base station to:
configure a second plurality of carriers for a user equipment (UE);
transmit, to the UE, a downlink control information (DCI) format for scheduling a plurality of resource blocks (RBs) on a first plurality of carriers of the second plurality of carriers for transmission, wherein the first plurality of carriers is indicated by a first indicator in the DCI format or configured to the UE by the base station; and
transmit downlink transmissions on the plurality of RBs based at least in part on the DCI format scheduling downlink transmissions, or receive uplink transmissions on the plurality of RBs based at least in part on the DCI format scheduling uplink transmissions.

15. A method performed by a user equipment (UE), comprising:
determining a payload size of a downlink control information (DCI) format, wherein the DCI format schedules a first plurality of carriers of a second plurality of carriers;
receiving the DCI format according to the determined payload size, wherein the first plurality of carriers is indicated by a first indicator of the DCI format or is configured by a base station;
determining resource blocks (RBs) assigned on the first plurality of carriers based on the DCI format; and
receiving downlink transmissions on the assigned RBs based at least in part on the DCI format scheduling the downlink transmissions, or transmitting uplink transmissions on the assigned RBs based at least in part on the DCI format scheduling the uplink transmissions.

16. A processor for wireless communication, comprising:
at least one controller coupled with at least one memory and configured to cause the processor to:
determine a payload size of a downlink control information (DCI) format, wherein the DCI format schedules a first plurality of carriers of a second plurality of carriers;
receive the DCI format according to the determined payload size, wherein the first plurality of carriers is indicated by a first indicator of the DCI format or is configured by a base station;
determine resource blocks (RBs) assigned on the first plurality of carriers based on the DCI format; and
receive downlink transmissions on the assigned RBs based at least in part on the DCI format scheduling the downlink transmissions, or transmit uplink transmissions on the assigned RBs based at least in part on the DCI format scheduling the uplink transmissions.

17. The processor of claim 16, wherein the first indicator indicates one or more of:
a first carrier of the first plurality of carriers and a number of the first plurality of carriers, wherein the first plurality of carriers are contiguously arranged in the second plurality of carriers according to a predefined order;
the number of the first plurality of carriers, wherein the first plurality of carriers are contiguously arranged in the second plurality of carriers according to a predefined order and the DCI format is received on a first carrier of the first plurality of carriers;
a carrier combination from a set of carrier combinations; or
a bitmap with each bit corresponding to a corresponding carrier of the second plurality of carriers.

18. The processor of claim 16, wherein to determine the assigned RBs on each of the first plurality of carriers, the at least one controller is configured to cause the processor to:
combine the first plurality of carriers into a virtual carrier according to a predefined order; and
determine the assigned RBs on the virtual carrier according to a second indicator in the DCI format and a resource allocation type associated with the first plurality of carriers.

19. The processor of claim 16, wherein to determine the assigned RBs on each of the first plurality of carriers, the at least one controller is configured to cause the processor to:
combine active bandwidth parts (BWPs) of the first plurality of carriers into a virtual BWP according to a predefined order; and
determine the assigned RBs on the virtual BWP according to a second indicator in the DCI format and a resource allocation type associated with the first plurality of carriers.

20. The processor of claim 19, wherein a field size of the second indicator is based at least in part on a resource allocation type associated with the first plurality of carriers and one of a maximum total number of RBs schedulable by the DCI format, a total number of RBs on the first plurality of carriers, or a total number of RBs on active bandwidth parts (BWPs) of the first plurality of carriers.
